(19) United States
(12) Patent Application Publication
(10) Pub. No.: US 2023/0243200 A1
(43) Pub. Date: Aug. 3, 2023

(54) VEHICLE DOOR SAFETY SYSTEM

(71) Applicant: Panasonic Automotive Systems Company of America, Division of Panasonic Corporation of North America, Peachtree City, GA (US)

(72) Inventors: GARRETT LASKOWSKI, LIDEN, MI (US); PADHU KANAGARAJ, FARMINGTON HILLS, MI (US)

(21) Appl. No.: 18/103,793

(22) Filed: Jan. 31, 2023

Related U.S. Application Data
(60) Provisional application No. 63/305,187, filed on Jan. 31, 2022.

(51) Int. Cl. E05F 15/40; B60J 5/10

(52) U.S. Cl. CPC E05F 15/40; B60J 5/101; E05Y 2201/43; E05Y 2400/40; E05Y 2400/54; E05Y 2900/546

(57) ABSTRACT

Examples of the disclosure relate to example systems and methods for operating a door opening system for a vehicle. An example system includes a motorized door, and a sensor configured to detect obstacles within a travel path of the motorized door. The system also includes one or more processors configured to receive a door control signal, and in response to the door control signal, determine whether an obstacle had been detected within the travel path of the motorized door. In response to determining that an obstacle has been detected, the one or more processors can block activation of the motorized door.

### CROSS-REFERENCE TO RELATED APPLICATIONS

This application claims the benefit of U.S. Provisional Application No. 63/305,187, filed on Jan. 31, 2022, which the disclosure of which is hereby incorporated by reference in its entirety for all purposes.

### FIELD OF THE INVENTION

The present disclosure generally relates to a method, system, and device for operating an automatic door for a vehicle.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Many vehicle models sold today come equipped with a rear door or hatch used for accessing the vehicle's cargo area. Some hatches are often motorized to allow for hands-free opening and closing. Such hatches can be activated by user input located in or around the vehicle, and may also be opened remotely through the vehicle's remote control key fob.

### SUMMARY

The present disclosure generally relates to techniques for implementing a hatch safety system for a vehicle. An example system in accordance with embodiments includes a motorized door, a sensor configured to detect obstacles within a travel path of the motorized door, and one or more processors. The processor(s) are configured to receive a door control signal, and in response to the door control signal, determine whether an obstacle had been detected within the travel path of the motorized door. In response to determining that an obstacle has been detected, the processor(s) block activation of the motorized door.

An example method in accordance with embodiments includes receiving a door control signal generated in response to user input. The method also includes in response to the door control signal, determining, via a sensor, whether an obstacle had been detected within a travel path of the motorized door. The method further includes in response to determining that an obstacle has been detected, blocking activation of the motorized door.

An example non-transitory computer-readable medium accordance with embodiments includes instructions to direct actions of one or more processors to operate a motorized door of a vehicle to receive a door control signal generated in response to user input. The non-transitory computer-readable medium includes instructions to, in response to the door control signal, determine whether an obstacle had been detected within a travel path of the motorized door. The non-transitory computer-readable medium includes instructions to in response to determining that an obstacle has been detected, block activation of the motorized door.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, where:

FIG. 1 is a block diagram of a system for implementing a door safety system for a vehicle in accordance with embodiments;

FIG. 2 is a process flow diagram of an example method for operating a door safety system for a vehicle in accordance with embodiments; and

FIG. 3 is a block diagram of an example computer-readable medium storing instructions, that when executed on one or more processors implements a motorized door opening system in a vehicle.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

This disclosure describes techniques for providing a safety system for operating a motorized vehicle door such as a rear hatch of a vehicle. Motorized hatches provide a convenient method for vehicle operators to access the cargo compartment of a vehicle. The cargo compartment may be a storage compartment of the vehicle. Such hatches can be activated (opened or closed) through buttons inside the car or remotely through the vehicles remote key fob. This means the hatch can be activated without the operator being present in the immediate area around the hatch. Accordingly, obstacles such as physical objects or people could be within the travel path of the hatch, which could result in a collision. In some cases, an obstruction such as a bike rack may be physically attached to the vehicle, resulting in possible damage to the obstruction, the hatch, or the hatch motor.

The present disclosure provides techniques for detecting the presence of obstacles in the travel path of a motorized vehicle door such as the vehicle's rear hatch. The disclosed system is configured to detect obstacles and interrupt the activation of the door so that the door doesn't collide with the obstacle. For example, a person may be passing by the rear of the vehicle when the vehicle owner activates the opening of the hatch. This system would detect the person and stop the command so that the hatch doesn't collide with the pedestrian. As another example, a person may be trying to put additional items into the cargo area while the hatch is closing. The system would detect the person and/or object and stop the movement of the hatch and/or initiate a re-opening of the hatch.

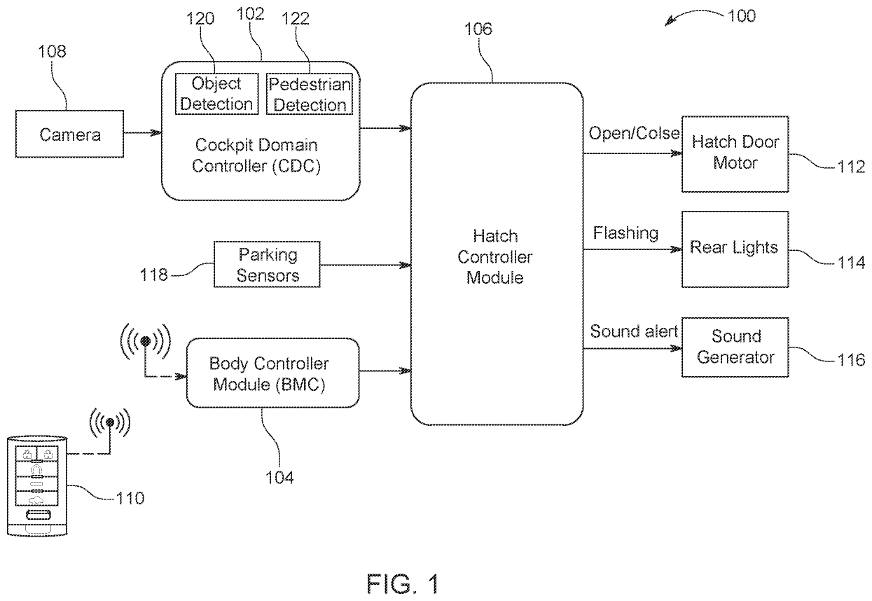

FIG. 1 is a block diagram of a system for implementing door safety system for a vehicle in accordance with embodiments. The system 100 may be included in any suitable type of automobile that is equipped with a motorized door opener. Embodiments of the present techniques are described in relation to a rear hatch of a vehicle. However, the techniques may be with other types of automatic doors or openings, such as a trunk, a tailgate, or a passenger door, for example.

The system 100 may be implemented using any suitable computer logic, including processing hardware or a combination or hardware and software. It will be appreciated that the architecture shown in FIG. 1 is one example architecture that can be used to implement the disclosed techniques. A suitable architecture in accordance with embodiments is not limited to the specific form or division of functions described in relation to FIG. 1.

The system 100 shown in FIG. 1 includes a cockpit domain controller 102, a body controller module 104, and a hatch controller module 106. The cockpit domain controller 102 is an electronic control unit (ECU) configured to provide infotainment and instrument cluster functionality. The cockpit domain controller 102 may control of various audio and video systems that provide information to the driver or other occupants, such as turn-by-turn navigation, hands-free calling, safety alerts, vehicle performance parameters, media streaming, and others.

The system 100 may also include a camera 108 communicatively coupled to the cockpit domain controller 102. The camera 108 may be disposed on the vehicle in any location that allows the camera view of the area effected by the motion of the hatch. For example, the camera 108 can be located above the hatch pointing downward and toward the rear of the vehicle. In some embodiments, the camera 108 includes range finding capabilities and can communicate one or more object distances to the cockpit domain controller 102. In some embodiments, the cockpit domain controller 102 can render video captured by the camera 108 to provide a view behind the vehicle during a reversing maneuver.

The body controller module 104 is an electronic control unit that controls various electronic devices through the vehicle, such as power windows, power mirrors, door locks, interior lighting, and others. The body controller module 104 may be configured to receive user input from various user input devices throughout the vehicle. Additionally, the body controller module 104 may have, or be coupled to, a wireless receiver configured to receive input from a remote key fob 110 of the vehicle.

The hatch controller module 106 is an electronic module used to control functions of the hatch, such as opening and closing. In the embodiment shown in FIG. 1, the hatch controller module 106 is also used to receive and process sensor data to determine whether the hatch can be safely opened. The hatch controller module 106 may be coupled to a hatch door motor 112, which the hatch controller module 106 can activate to open or close the hatch or stop the hatch from moving. In some embodiments, the hatch controller module 106 is also coupled to various alert devices, such as rear lights and/or a sound generator. The rear lights 114 may be, for example, brake lights, reverse lights, or other lights, including lights dedicated for the purpose of indicating activity of the hatch. The sound generator 116 may be, for example, a speaker, a buzzer, the car horn, or others.

The hatch controller module 106 can receive input from the cockpit domain controller 102, the body controller module 104, and the parking sensors 118. A command from the user to activate the hatch may be received at the hatch controller module 106 from the body controller module 104. The command can originate from the vehicle's remote key fob 110 or from an input device such as a button inside the vehicle or outside of the vehicle on or near the hatch. Upon receiving a command from the user to open the hatch, the body controller module 104 can send a hatch control signal to the hatch controller module 106. Once the hatch controller module 106 receives the hatch control signal, the hatch controller module 106 processes one or more inputs to determine whether it is currently safe to operate the hatch. One of those inputs may be received from the cockpit domain controller 102.

In response to the hatch control signal, the cockpit domain controller 102 can process video received from the camera 108 to determine if the path of the hatch is free of obstacles. The analysis may be performed, for example, by an object detection code 120 and/or a pedestrian detection code 122. The object detection code 120 and/or a pedestrian detection code 122 may be developed using machine learning algorithms trained to detect relevant objects. In some embodiments, the cockpit domain controller's detection code, including the object detection code 120 and/or a pedestrian detection code 122, may be configured to determine distance information and positional information regarding objects within view of the camera and compare this information with a known map of the hatch's path of motion. If the cockpit domain controller 102 determines that the path is free of obstacles, the cockpit domain controller 102 can send a signal to the hatch controller module 106 indicating that the path is free of obstacles and that the hatch can be safely opened. Otherwise, the cockpit domain controller 102 sends a signal to the hatch controller module 106 indicating that the activation of the hatch is to be blocked.

In addition to or in place of receiving a signal from the cockpit domain controller 102, the hatch controller module 106 may also receive signals from one or more parking sensors 118. The parking sensors 118 may be disposed on the rear of the vehicle such as imbedded in the vehicle's rear bumper. The parking sensors 118 may be motion sensors, ultrasonic proximity sensors, electromagnetic proximity sensors, and others. In response to the hatch control signal, signal from the parking sensors 118 can be processed to determine if the travel path of the hatch is free of obstacles. If the parking sensors detect an obstacle in the path of the hatch, the parking sensors 118 can send a signal to the hatch controller module 106 indicating that the activation of the hatch is to be blocked.

In some cases, when the user issues the command to open the hatch, the vehicle may be turned off, in which case the cockpit domain controller 102, camera 108, and/or parking sensors 118 may be turned off and inactive. In such cases, the body controller module 104, when issuing the hatch control signal may also command the camera 108, the cockpit domain controller 102, and/or the parking sensors 118 to turn on and become active. Such activation command may be delivered to these components through the vehicle's communication network, such the vehicle's controller area network, or may be delivered through a separate wireless channel, such as Wi-Fi or Bluetooth.

If the hatch controller module 106 receives the command to activate the hatch, the hatch controller module 106 processes the signals from the cockpit domain controller 102 and/or the parking sensors 118 to determine whether to activate the hatch door motor 112 to either open or close the hatch. If the signals received from the cockpit domain controller 102 or parking sensors 118 indicate there are obstacles in the path of the hatch, the hatch door motor 112 is not activated. Optionally, the hatch controller module 106 may also activate the rear lights 114 and/or the sound generator 116 to indicate that the activation of the hatch has been prevented due to an obstacle. This can alert the operator to the presence of obstacles and may also alert bystanders that they are in the path of the hatch.

In some embodiments, the system 100 may continue to monitor for potential obstacles after the hatch has been activated. If an obstacle is detected after activating the hatch, the continued operation of hatch may be interrupted, and in some cases may be reversed. For example, if a person entered the travel path of the hatch as the hatch is closing, the system may cause the hatch to stop moving and may cause the hatch to remain in the partially closed state or command it to re-open.

Simplified examples are presented herein. However the teachings shown here can be extrapolated beyond the examples shown to include any number of different functionalities. Additionally, it is to be understood that the block diagram of FIG. 1 is not intended to indicate that the system 100 is to include all of the components shown in FIG. 1. Rather, the system 100 can include fewer or additional components not illustrated in FIG. 1.

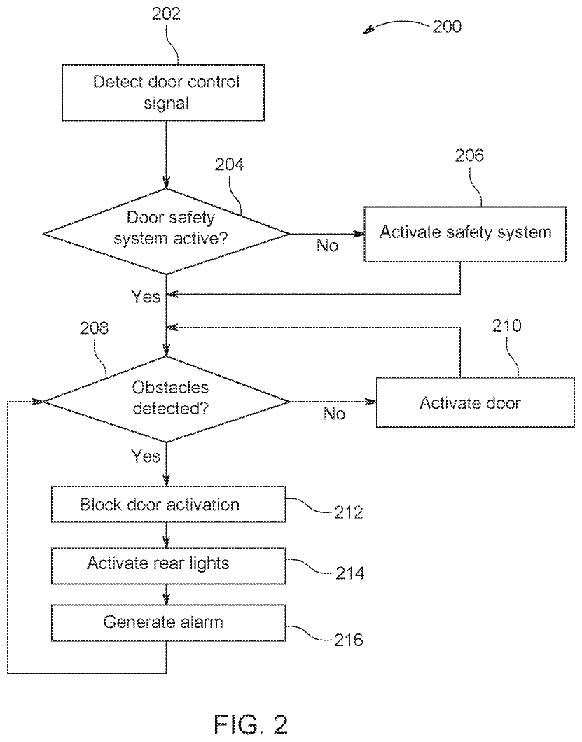

FIG. 2 is a process flow diagram of an example method for operating a door safety system for a vehicle in accordance with embodiments. Each of the functions of this method 200 can be performed by individual components, in parallel, and/or in an ongoing basis to form a pipeline of continuously updating information and actions. The method may be implemented by logic embodied in hardware, such as logic circuitry or one or more processors configured to execute instructions stored in a non-transitory, computer-readable medium. For example, the method 200 may be performed by the system 100 of FIG. 1. The method 200 may be performed to control a motorized door of a vehicle, such as a hatch, a trunk, or a passenger door. The method may begin at block 202.

At block 202, a door control signal is detected. For example, the door control signal may be a hatch control command. The door control signal may be initiated by vehicle operator to open or close the door, and may be received from a button inside the vehicle or a remote key fob, for example.

At block 204, a determination is made regarding whether the door safety system or components thereof are active. For example, an active door safety system or active components may be powered on and operational. Components of the door safety system may include one or more of the cockpit domain controller 102, the hatch controller module 106, the camera 108, and the parking sensors 118 described in FIG. 1. However, other hatch safety systems in accordance with embodiments may have a different components and/or different combinations of components. For example, components for determining the presence of objects in the vicinity of the vehicle may include components of an Advanced Driver-Assistance System (ADAS) if so equipped in the vehicle. The ADAS is an electronic system employed in some vehicles to provide advanced driving and parking functions, such as collision avoidance, lane centering assistance, adaptive cruise control, and others. The ADAS may include various subsystems for detecting and identifying objects around the vehicle. Such subsystems can include radar subsystems, lidar subsystems, camera-based computer vision systems, and others.

If at block 204, the door safety system is active, the process flow advances to block 208. Otherwise, if the door safety system or components thereof are not active, the process flow advances to block 206, and the door safety system is activated, by powering up any inactive components. Once the door safety system is activated, the process flow advances to block 208.

At block 208, a determination is made regarding whether any obstacles have been detected in the movement path of the door. This determination may be made based on signals received from the cockpit domain controller 102, camera 108, parking sensors 118, and others components, such as the vehicle's ADAS or subsystems thereof.

If at block 208, no obstacles are detected, the process flow advances to block 210 and the door is activated. For example, the door may be opened or closed. Otherwise, if obstacles are detected, the process flow advances to block 212. In some embodiments, after the hatch is activated, the process flow may return from block 210 back to block 208 to continue to monitor for the presence of obstacles while the door is in motion.

At block 212, the activation of the door is blocked. Also at block 212, the door movement may be reversed if the door was in motion when the obstacle was detected. The process may then optionally proceed to blocks 214 and/or blocks 216. At block 214, lights such as the rear lights 114 of FIG. 1 are activated to, for example, produce a flashing pattern. At block 216, an audible alarm may be generated using a sound generator such as the sound generator 116 of FIG. 1.

In some embodiments, the process flow may then return to block 208 to further monitor for the presence of obstacles, in which case, the removal of the obstacle may allow the door to be activated at block 210.

The method 200 should not be interpreted as meaning that the blocks are necessarily performed in the order shown. Furthermore, fewer or greater actions can be included in the method 200 depending on the design considerations of a particular implementation.

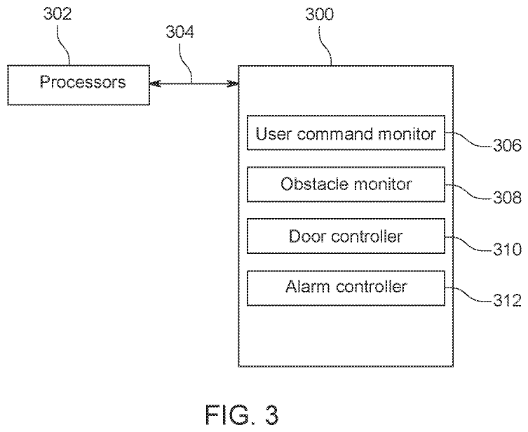

FIG. 3 is a block diagram of an example computer-readable medium storing instructions, that when executed on one or more processors implements a motorized door opening system in a vehicle. The tangible, non-transitory, computer-readable medium 300 includes instructions that, when executed by the one or more processors 302 can direct the processors 302 to implement a safety protocol for the door opening system. The tangible, non-transitory, computer-readable medium 300 may be accessed by the one or more processors 302 over a computer interconnect 304.

The processors 302 may be implemented as processing hardware or a combination of hardware and software. For example, the processors 302 may be implemented on a microprocessor such as an Application Specific Integrated Circuit (ASIC), as software or firmware executing on a general purpose processor, and the like. Additionally, the one or more processors 302 may be a single processor or may be a set of processors each dedicated to performing a subset of tasks within the method. For example, the processors 302 may include the cockpit domain controller 102, the body controller module 104, and the hatch controller module 106 shown in FIG. 1.

The instructions stored to the computer-readable medium 300 include a user command monitor 306 that, when executed by the processor, causes the processor to monitor for a door control signal generated in response to user input. The instructions stored to the computer-readable medium 300 also include an obstacle monitor 308 that, when executed by the processor, causes the processor to determine whether an obstacle had been detected within the travel path of the motorized door in response to receiving the door control signal. The obstacle monitor 308 may also cause object detection subsystems within the vehicle to be activated in response to receiving the door control signal. For example, one or more sensors may be activated in response to receiving the door control signal. The object detection subsystems may include the cockpit domain controller 102, the camera 108, and/or the parking sensors 118 of FIG. 1.

The instructions stored to the computer-readable medium 300 also include a door controller 310 that, when executed by the processor, causes the processor to activate the door in response to detecting that no obstacles are detected, or block activation of the door in response to detecting that an obstacle is detected. In some embodiments, the door controller 310 may also cause movement of the door to be reversed to move in a reverse direction in response to detecting an obstacle while the door is in motion. The instructions stored to the computer-readable medium 300 also include an alarm controller 312 that, when executed by the processor, causes the processor to activate an alarm by activating one or more lights and/or a sound generator in response to determining that an obstacle has been detected.

While the invention may be susceptible to various modifications and alternative forms, specific embodiments have been shown by way of example. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A door opening system for a vehicle, comprising:
a motorized door;
a sensor configured to detect obstacles within a travel path of the motorized door; and
one or more processors configured to:
receive a door control signal;
in response to the door control signal, determine whether an obstacle had been detected within the travel path of the motorized door; and
in response to determining that an obstacle has been detected, block activation of the motorized door.

2. The door opening system of claim 1, comprising:
in response to the door control signal, activate the sensor and the one or more processors.

3. The door opening system of claim 1, comprising:
in response to determining that an obstacle has not been detected, allow activation of the door.

4. The door opening system of claim 1, comprising:
monitoring, via the sensor, the travel path of the motorized door while the motorized door is in motion.

5. The door opening system of claim 1, comprising:
in response to determining that an obstacle has been detected while the door is moving, activate the motorized door to move in a reverse direction.

6. The door opening system of claim 1, comprising:
in response to determining that an obstacle has been detected, activate one or more lights.

7. The door opening system of claim 1, comprising:
in response to determining that an obstacle has been detected, activate a sound generator.

8. The door opening system of claim 1, wherein the motorized door is a rear hatch configured to provide access to a storage compartment of the vehicle.

9. The door opening system of claim 1, wherein the sensor is a camera.

10. The door opening system of claim 1, wherein the sensor is a parking sensor.

11. A method of operating a motorized door of a vehicle, comprising:
receiving a door control signal generated in response to user input;
in response to the door control signal, determining, via a sensor, whether an obstacle had been detected within a travel path of the motorized door; and
in response to determining that an obstacle has been detected, blocking activation of the motorized door.

12. The method of claim 11, comprising:
in response to the door control signal, activating the sensor.

13. The method of claim 11, comprising:
in response to determining that an obstacle has not been detected, allowing activation of the motorized door.

14. The method of claim 11, comprising:
monitoring, via the sensor, a travel path of the motorized door while the motorized door is in motion; and
in response to determining that an obstacle has been detected while the door is moving, activating the motorized door to move in a reverse direction.

15. The method of claim 11, comprising:
in response to determining that an obstacle has been detected, generating an alarm by activating one or more lights or a sound generator.

16. A non-transitory computer-readable medium comprising instructions to direct actions of one or more processors to operate a motorized door of a vehicle, the instructions to direct the one or more processors to:
receive a door control signal generated in response to user input;
in response to the door control signal, determine whether an obstacle had been detected within a travel path of the motorized door; and
in response to determining that an obstacle has been detected, block activation of the motorized door.

17. The non-transitory computer-readable medium of claim 16, comprising instructions to direct the one or more processors to:
in response to the door control signal, activate a sensor.

18. The non-transitory computer-readable medium of claim 16, comprising instructions to direct the one or more processors to:
in response to determining that an obstacle has not been detected, allow activation of the motorized door.

19. The non-transitory computer-readable medium of claim 16, comprising instructions to direct the one or more processors to:
monitor, via the sensor, a travel path of the motorized door while the motorized door is in motion; and
in response to determining that an obstacle has been detected while the motorized door is moving, activate the motorized door to move in a reverse direction.

20. The non-transitory computer-readable medium of claim 16, comprising instructions to direct the one or more processors to:
in response to determining that an obstacle has been detected, generate an alarm by activating one or more lights or a sound generator.
